(19) United States
(12) Patent Application Publication
(10) Pub. No.: US 2025/0282117 A1
(43) Pub. Date: Sep. 11, 2025

(54) SYSTEM AND METHOD FOR FIBERGLASS REINFORCED PANEL

(71) Applicant: Crane Composites, Inc., Channahon, IL (US)

(72) Inventors: Matthew Shields, Chicago, IL (US); Jacob Butman, Highland Park, IL (US); Sharon Kirk, New Lenox, IL (US); Alan Paramo, Joliet, IL (US); Nicole Yuede, Oakbrook Terrace, IL (US)

(21) Appl. No.: 19/009,883

(22) Filed: Jan. 3, 2025

Related U.S. Application Data
(60) Provisional application No. 63/562,590, filed on Mar. 7, 2024.

(51) Int. Cl. B32B 5/24; B32B 5/18; B32B 7/12; B32B 37/26

(52) U.S. Cl. CPC B32B 5/245; B32B 5/18; B32B 7/12; B32B 37/26; B32B 2037/268; B32B 2266/08; B32B 2305/022

(57) ABSTRACT

A self-bonding panel comprising a fiberglass reinforced panel having a front side and a back side. At least one adhesive layer is applied to the backside of the fiberglass reinforced panel. At least one release liner layer is applied to a surface of the at least one adhesive layer opposite the fiberglass reinforced panel.

### CROSS-REFERENCE TO RELATED APPLICATION AND PRIORITY CLAIM

This application claims priority under 35 U.S.C. § 119 (e) to U.S. Provisional Patent Application No. 63/562,590 filed on Mar. 7, 2024, which is hereby incorporated by reference in its entirety.

### TECHNICAL FIELD

The following disclosure relates to fiberglass reinforced panels, and more particularly, to fiberglass reinforced panels having a self-bonding surface.

### BACKGROUND

Fiberglass reinforced panels (FRPs) are widely used within the construction industry. Normal application of FRPs require the application of a wet trowel adhesive to a backside of the FRP prior to its application to a substrate. The substrate may comprise in some implementations a gypsum wallboard or other solid substrates that also require the application of a wet trowel adhesive. After application of the FRP to the substrate it may be moved around to provide a final location position. The wet trowel adhesive will then dry, securing the FRP in place on the substrate. The application of FRPs in this manner requires a great deal of labor and time in the creation of the wet trowel adhesive used to secure the FRPs to a substrate, the application of the wet trowel adhesive to a backside of the FRP and the positioning of the FRP on a substrate. The current application process of FRPs creates a labor and time intensive process at the construction site. Thus, a structure and method for improving the speed and efficiency for the application of FRPs to substrates would provide a great benefit with the associated savings in both manpower and time and provide uniformity and consistency in adhesive applying the FRP.

### SUMMARY

The present disclosure illustrates embodiments of various self-bonding FRPs.

Other technical features may be readily apparent to one skilled in the art from the following figures, descriptions, and claims. A self-bonding panel comprises a fiberglass reinforced panel having a front side and a back side. At least one adhesive layer is applied to the backside of the fiberglass reinforced panel. At least one release liner layer is applied to a surface of the at least one adhesive layer opposite the fiberglass reinforced panel.

Before undertaking the DETAILED DESCRIPTION below, it may be advantageous to set forth definitions of certain words and phrases used throughout this patent document. The term “couple” and its derivatives refer to any direct or indirect interaction between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings in which like reference numerals represent like parts:

FIG. 1 illustrates an example of an application of multiple FRPs to a structure in accordance with various embodiments of the present disclosure;

FIG. 2 illustrates a view of proposed embodiments of the multiple layers of an FRP in accordance with various embodiments of the present disclosure;

FIG. 3 illustrates the application of an FRP to a substrate after having its release liner layer removed in accordance with various embodiments of the present disclosure;

FIG. 4A illustrates a first embodiment of an FRP, in accordance with various embodiments of the present disclosure;

FIG. 4B illustrates an alternative embodiment of the first embodiment of the FRP;

FIG. 5 illustrates a second embodiment of an FRP, in accordance with various embodiments of the present disclosure;

FIG. 6 illustrates a third embodiment of an FRP, in accordance with various embodiments of the present disclosure;

FIG. 7 illustrates a fourth embodiment of an FRP, in accordance with various embodiments of the present disclosure;

FIG. 8 illustrates an FRP connected to a substrate in accordance with various embodiments of the present disclosure;

FIG. 9 illustrates a division bar trim accessory for installing FRPs in accordance with various embodiments of the present disclosure;

FIG. 10 illustrates an endcap trim accessory for installing FRPs in accordance with various embodiments of the present disclosure;

FIG. 11 illustrates an inside corner trim accessory for installing FRPs in accordance with various embodiments of the present disclosure;

FIG. 12A-12C illustrate a top view of the adhesive and release liner layers laminated to the FRP; and

FIG. 13 illustrates a flow diagram of the installation of the self-bonding FRP to a substrate.

### DETAILED DESCRIPTION

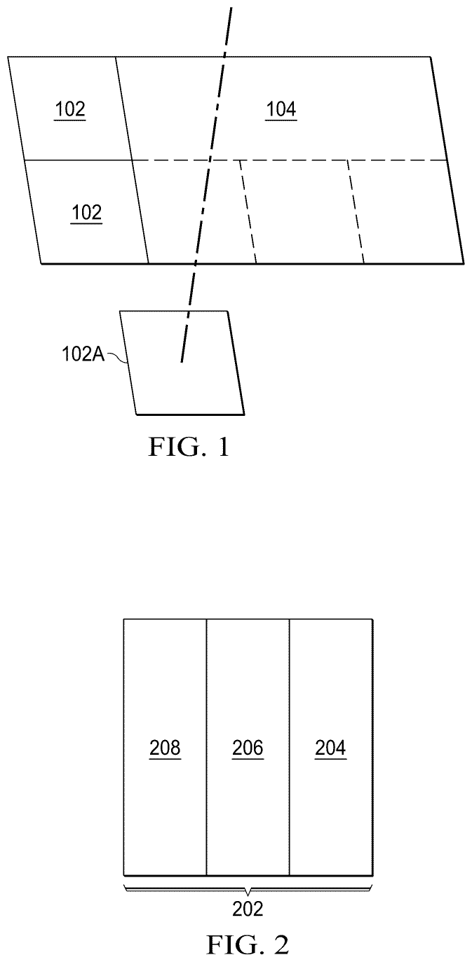

FIGS. 1 through 13, discussed below, and the various embodiments used to describe the principles of the present disclosure are by way of illustration only and should not be construed in any way to limit the scope of the disclosure. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

FIG. 1 illustrates the manner in which individual fiberglass reinforced panels (FRPs) 102 are connected to a structure 104. The structure 104 may comprise a substrate on which an FRP 102 may be mounted. This may include walls, ceilings, floors, ducts, or any other flat substrate to which the FRP 102 may be mounted. The FRP 102 may be used in construction of buildings, homes, recreational vehicles, aircraft, or any other application that would need the application of an FRP 102 to any substrate. Each of the FRPs 102 are secured to the structure 104 in the manner which will be more fully described hereinbelow. FRP 102A is shown prior to its securing to the structure 104 and is placed in a position adjacent to other FRPs 102 on the structure 104 so that it may be secured in place. While the present disclosure describes the FRP 102 as comprising a single panel, the implementation of the FRP 102 may also comprise a roll or coil of FRP material that may be rolled out along a substrate and then cut to a desired length before installation as described herein below.

FIG. 2 illustrates a self-bonding FRP 202. The self-bonding FRP 202 comprises three separate layers. The process for creating the self-bonding FRP 202 laminates an adhesive layer 206 to the back side of an FRP panel 204. These three separate layers comprise the FRP 204, the adhesive layer 206, and the release liner layer 208. Added to the FRP panel 204 are the adhesive layer 206 and the release liner layer 208. The adhesive layer 206 enables the FRP 204 to be secured to a substrate. The adhesive layer 206 is pressure sensitive such that FRP 204 may be placed in a desired initial position and finally secured to a structure by applying pressure to a front surface of the FRP 204. The release liner layer 208 comprises a removable film, poly coated kraft paper, direct coated paper etc. which protects adhesive layer 206 until the FRP 204 is to be secured to a structure. While the preferred embodiment uses a pressure sensitive adhesive, other types of adhesives may be used if the adhesive provides the adhesive layer 206 the ability to bond to both of the surfaces that the FRP panel 204 is being bonded to and to the FRP 204. Additionally, rather than comprising a pressure sensitive adhesive, the adhesive layer 206 may comprise a moisture cure adhesive or other type of adhesive that is activated by any means enabling the FRP 204 to be mounted to a particular substrate.

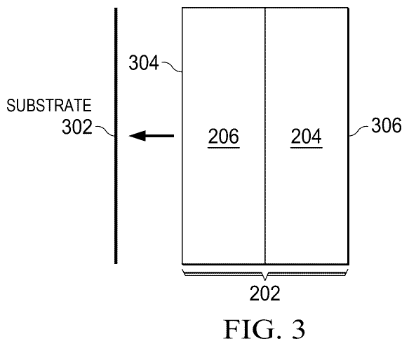

FIG. 3 illustrates the self-bonding FRP 202 that is being secured to a particular substrate 302. In the illustration of FIG. 3, the release liner layer 208 has been removed from the backside 304 of the adhesive layer 206. The release liner layer 208 may then be disposed of. The backside 304 of the adhesive layer 206 is placed upon the substrate 302. As mentioned previously, the substrate 302 may comprise any substrate that may need coverage with the self-bonding FRP 202. Once the desired position for the FRP 204 is achieved, a pressure may be applied to the front surface 306 of the self-bonding FRP 202 to secure the self-bonding FRP in its final desired position upon the substrate 302. Activation may occur in other ways corresponding to the adhesive used (i.e., pressure for PSA, water for moisture cured, etc.). If repositioning is desired, the self-bonding FRP 202 can be removed and repositioned on the substrate 302. A self-bonding FRP 202 of this type will reduce labor and the time required to install as compared to current methods for installing a FRPs using a wet trowel adhesive.

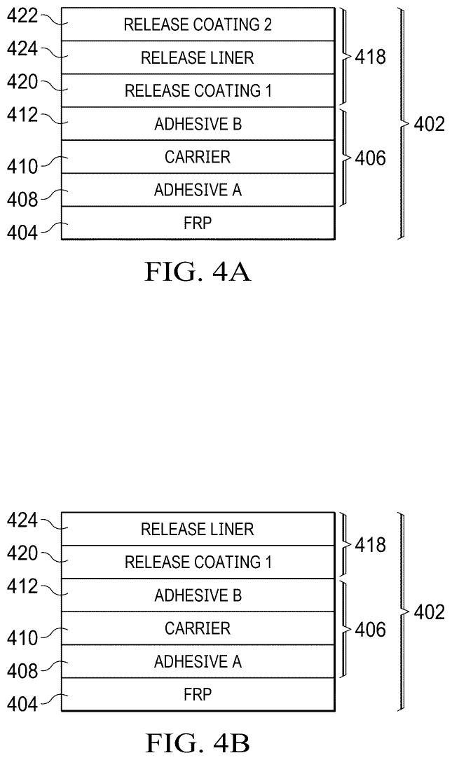

FIG. 4A illustrates a first embodiment of a self-bonding FRP 402 in accordance with various embodiment of the present disclosure. The portion that is applied to the substrate includes the FRP 404 having a number of adhesive layers 406 applied to a backside thereof. The adhesive layers 406 consist of an adhesive A layer 408 applied directly to the backside of the FRP 404, a carrier layer 410 located on top of the adhesive A layer 408, a second adhesive B layer 412 consisting of adhesive located on top of the carrier layer 410. When the adhesive B layer 412 contacts a substrate of the structure, the adhesive B layer 412 maintains a fixed position of the FRP 404 to the structure. Adhesive A layer 408 comprises a permanently bondable solvent-based-adhesive for application to the backside of the FRP 404.

In one embodiment, the carrier layer 410 comprises a foam carrier that can range from 0.1 mm-200 mm in thickness and provides a number of valuable qualities to adhesive layers 406. Due to the qualities such as resilience, excellent buoyancy, good thermal insulation, excellent strength and shock absorption, low water absorption, impervious to mildew, mold, rot, and bacteria, excellent chemical resistance, non-toxic, and contains no CFCs, HCFCs, or hydrocarbon blowing agents. Carrier layer 410 has smooth skin on both sides and incredibly fine closed cells. The physical attributes carrier layer 410 include lightness, flexibility, softness to the touch, strength, toughness and resistance to moistures, chemicals and extreme temperatures. Carrier layer 410 typically provides improved dimensional consistency and stability over a wide range of fabrication techniques and end use conditions. Carrier layer 410 additionally provides superior thermal stability and insulating properties. The high buoyancy, low moisture permeability and ability to effectively insulate against sound and vibration make polyolefin foams useful in the building and construction sector. Additionally, the carrier layer 410 is UV and fungus resistant. The carrier layer 410 can withstand service temperatures as low as −80° C. and as high as 100° C. Other types of materials may be used for the carrier layer 410 including Paper, Cloth, Felt, Foam, Metal Foil, Plastic Film/Polymer, PET/Polyester, Polyimide, PVC, Rubber, Silicone, Acrylic, Glass/Fiberglass, Filament and Fluoropolymer/PTFE/PVDF. The adhesive layers 406 that will be applied directly to the substrate to secure the self-bonding FRP 402 comprise a high performance repositionable solvent based adhesive. The adhesive layers 406 allows for the removal and repositioning of the self-bonding FRP 402 against multiple substrates to provide a permanent bond.

When the self-bonding FRP 402 has yet to be applied to a substrate, the adhesive B layer 412 is protected by a release liner layers 418. The release liner layers 418 comprise a double coated tape applied to the back side of the self-bonding FRP 402 on the adhesive layers 406 providing a poly-coated paper, film, or paper siliconized release liner. The release liner layers 418 further comprise a tight release coating 1 layer 420 and an easy release coating 2 layer 422 that are separated by a natural or bleached polyethylene kraft, film, or paper differential release liner 424. When used, the release liner layers 418 are removed from the adhesive B layer 412 and expose the adhesive B layer 412 such that it may be used to secure the self-bonding FRP 402 to a structure. The release liner coatings may comprise any low surface energy coating using in industry, such as, silicone, fluoropolymers, carbamates, polyacrylates, polyolefins, fluorocarbons, chromium stearate complexes, silicone containing copolymers, polymers with long alkyl or fluoroalkyl side chains, etc. While the present description is envisioned with respect to connecting the FRP 404 to a substrate, the FRP 404 may be connected to any appropriate structure.

Referring now to FIG. 4B, there is illustrated an alternative embodiment of the self-bonding FRP 402 of FIG. 4A. In this embodiment, the structure of the self-bonding FRP 402 is the same with the exception that the release coating 2 layer 422 is not present. In this embodiment, the release liner 424 remains with the self-bonding FRP 402 until removed to enable application of the self-bonding FRP to a substrate.

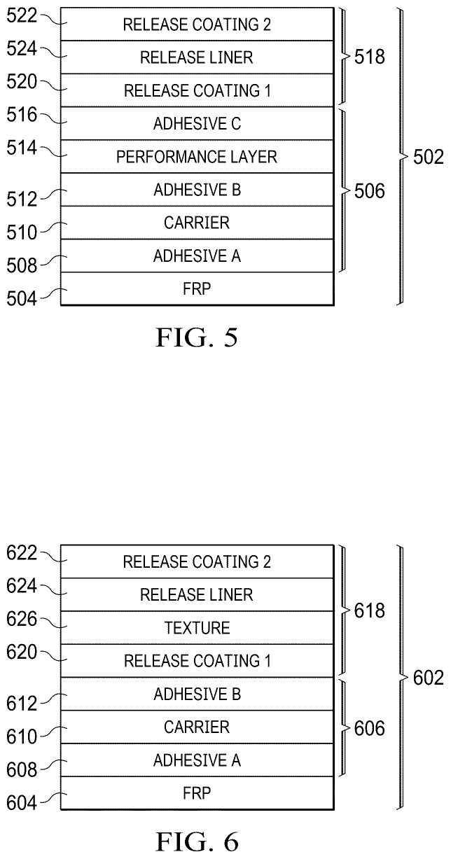

FIG. 5 illustrates a second embodiment of a self-bonding FRP 502 in accordance with various embodiments of the present disclosure. The portion that is applied to the substrate includes the FRP 504 having a number of adhesive layers 506 applied to a backside thereof. The adhesive layers 506 consist of an adhesive A layer 508 applied directly to the backside of the FRP 504, a carrier layer 510 located on top of the adhesive A layer 508, a second adhesive B layer 512 consisting of adhesive, with a performance layer 514 located on top of the second adhesive B layer 512 which has a third adhesive C layer 516 located on top of the performance layer 514. The performance layer 514 provides cohesive strength between the adhesive layers 516 and 512 and may comprise tissue or other supporting material. When the adhesive C layer 516 contacts a substrate of the structure, the adhesive C layer 516 maintains a fixed position of the FRP 504 to the structure. Adhesive A layer 508 comprises a permanently bondable solvent-based adhesive for application to the backside of the FRP 504.

In one embodiment, the carrier layer 510 comprises a foam carrier that can range from 0.1 mm-200 mm in thickness and provides a number of valuable qualities to adhesive layers 506. The carrier layer 510 has characteristics similar to those discussed above with respect to FIG. 4.

The adhesive layers 506 that will be applied directly to the structure to secure the self-bonding FRP 502 is a high performance repositionable solvent based adhesive. The adhesive layer 506 allows for the removal and repositioning of the self-bonding FRP 502 against multiple substrates to provide a permanent bond.

When the self-bonding panel 502 has yet to be applied to a substrate, the adhesive layer C layer 516 is protected by a release liner layers 518. The release liner layers 518 comprise a double coated tape applied to the back side of the self-bonding FRP 502 on the adhesive layers 506 providing a poly-coated paper, film, or paper siliconized release liner. The release liner layers 518 further comprise a tight release coating 1 layer 520 and an easy release coating 2 layer 522 that are separated by a natural or bleached Polyethylene kraft, film, or paper differential release liner 524. When used, the release liner layers 518 are removed from the adhesive layers 516 or 512 (the outermost adhesive layer) and expose the adhesive C layer 516 such that it may be used to secure the self-bonding FRP 502 to a structure. While the present description is envisioned with respect to connecting the FRP 504 to a substrate, the FRP 504 may be connected to any appropriate structure.

FIG. 6 illustrates a third embodiment of a self-bonding FRP 602 in accordance with various embodiments of the present disclosure. This embodiment includes substantially the same layers as that previously discussed with respect to FIG. 4A. Additionally, a texture liner layer 626 is included between release liner layer 624 and the release coating 1 layer 620. Texture layer 626 comprises a clear printed texture or structured embossment of poly layer within the release liner to mechanically enhance repositionability of adhesive to substrate by imparting peaks and valleys into adhesive B layer 612 for less intimate contact prior to applying pressure. The texture layer 626 may also be either embossed or printed onto the release liner 624. The texture layer 626 may also comprise an embossed film that comprises a coated layer having particles in the layer (a matte surface with texture).

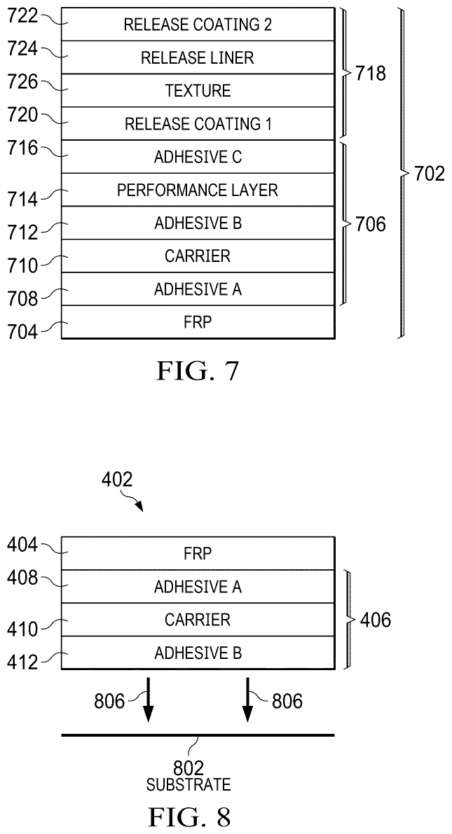

FIG. 7 illustrates a fourth embodiment of a self-bonding FRP 702 in accordance with various embodiments of the present disclosure. The portion that is applied to the substrate includes the FRP 704 having a number of adhesive layers 706 applied to a backside thereof. The adhesive layers 706 consist of a first adhesive layer 708 applied to the backside of the FRP 704, a carrier layer 710 located on top of the first adhesive layer 708, a second adhesive layer 712 consisting of adhesive located on top of the carrier layer 710, and an performance layer 714 located on top of the second adhesive layer 712, which has a third adhesive C layer 716 located on top of the performance layer 714, if present. When the adhesive C layer 716 contacts a substrate of a structure, the adhesive C layer 716 maintains a connected position of the FRP 704 to the substrate. Adhesive layer 708 comprises a permanently bondable solvent-based adhesive for application to the backside of the FRP 704. The adhesive layer to be applied to the structure or other substrates is high performance repositionable solvent adhesive.

In one embodiment, carrier layer 710 comprises a foam carrier that can range from 0.1 mm-200 mm in thickness and provides a number of valuable qualities to the adhesive layers 706. The carrier layer 510 has characteristics similar to those discussed above with respect to FIG. 4.

When the adhesive panel has yet to be applied to a structure, the adhesive C layer 716 is protected by a release liner layers 718. The release liner layers 718 comprise a double coated tape applied to the back side of the FRP 704 on the adhesive layers 706 providing a poly-coated kraft, film, or paper release liner. The liner layers 718 comprise a tight release coating 1 layer 720 and an easy release coating 2 layer 722 that are separated by a poly-coated Kraft, film, or paper release liner 724. Texture layer 726 comprises a clear printed texture or structured embossment of poly layer within the release liner to mechanically enhance repositionability of adhesive to substrate by imparting peaks and valleys into adhesive C layer 716 for less intimate contact prior to applying pressure. The texture layer 726 may also be either embossed or printed onto the release liner 724. The texture layer 726 may also comprise an embossed film that comprises a coated layer having particles in the layer (a matte surface with texture).

When removed, the release liner layers 718 are removed from the adhesive layers 712 or 716 and expose the adhesive C layer 716 such that it may be used to secure the FRP 704 to a structure. While the present description is made with respect to connecting the FRP 704 to a wall substrate, the FRP 704 may be connected to any appropriate structure.

Referring now to FIG. 8, there is illustrated the self-bonding FRP 402 of FIG. 4 and one manner that the panel is mounted to a substrate 802. Once the release liner layers are removed from the adhesive layers 406 mounted to the back surface of the FRP 404, an adhesive B layer 412 is exposed. The adhesive B layer 412 may be secured to a substrate 802 to secure the FRP 404 to the substrate 802. If the self-bonding FRP 402 is merely placed on the substrate 802 without applying a surface pressure to the FRP 404 in the direction generally shown by the arrows 806, the self-bonding FRP 402 can be easily repositioned by pulling the panel off of the substrate 802 and repositioning the panel to a desired position. Once a final position of the self-bonding FRP 402 has been achieved, pressure may be placed on the front surface of the FRP 404 to secure the adhesive layer B 412 to the substrate 802.

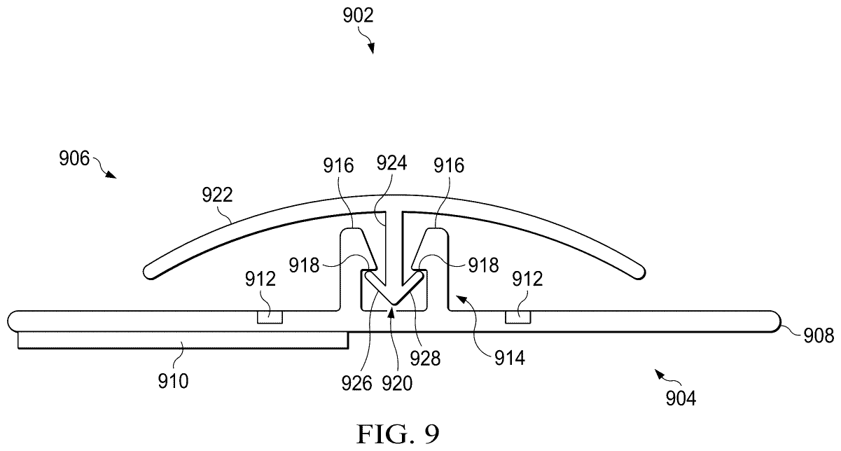

FIG. 9 illustrates a division bar trim accessory 902 for speeding the installation process of a self-bonding FRP 402. The division bar trim accessory 902 enables the interconnection of two adjacent self-bonding FRPs 402 on a substrate. The division bar trim accessory 902 includes a first portion 904 that connects to a substrate and a second portion 906 that connects with and secures edges of a pair of adjacent self-bonding FRPs 402 on a substrate. The first portion 904 includes a backplate 908 that connects to a substrate. At least a portion of a back side of the backplate 908 includes an adhesive 910 that is used for securing the backplate 908 of the first portion 904 to the substrate. In one embodiment, the adhesive 910 only covers half of the back side of the backplate 908 (other areas may be covered). The remaining half of the backside of the backplate 908 includes no adhesive 910 to allow the non-adhesive portion of the backplate to tuck behind an existing FRP 404 on a substrate. While covering half of the back side of the backplate 908 with adhesive 910 has been described, it will be understood that lesser and greater areas on the back side of the backplate 908 may be covered with the adhesive 910.

The front side of the backplate 908 includes edge markers 912 marking the edge placement of a self-bonding FRP 402. The front side of the backplate 908 of the first portion 904 has a female connector 914 extending perpendicularly therefrom. The female connector 914 includes a pair of latching members 916 extending perpendicular from the backplate 908. Each of the pair of latching members 916 define a ledge 918 for securing a male connector 920. The latching members 916 may flexibly move laterally to allow disengagement of the male connector 920.

The second portion 906 of the division bar trim accessory 902 comprises a flexible plate 922 and the male connector 920 extending therefrom. The flexible plate 922 has a slightly curved shape where the edges extend downward toward the first portion 904 for holding edges of adjacent self-bonding FRPs 402 against the front surface of the backplate 908. The flexible nature of the flexible plate 922 enables the division bar trim accessory 902 to accommodate multiple self-bonding FRP 402 thicknesses. The flexible nature further enables the flexible plate 922 to provide a holding force against the edges of the adjacent self-bonding FRPs 402.

The male connector 920 includes a horizontal member 924 extending perpendicularly from the surface of the flexible plate 922. At the end of the horizontal member 924, opposite from the connection point with the flexible plate 922, an arrow shaped connector includes a first wing 926 and a second wing 928 enabling the male connector 920 to latch into the female connector 914. When snapped into place, the first and second wings 926, 928 click into place on the ledges 918 of the female connector 914 to secure the flexible plate 922 to the backplate 908. This enables the division bar trim accessory 902 to secure edges of self-bonding FRPs 402 to a substrate. The division bar trim accessory 902 speeds up install times and enhances ease of use of the self-bonding FRP 402.

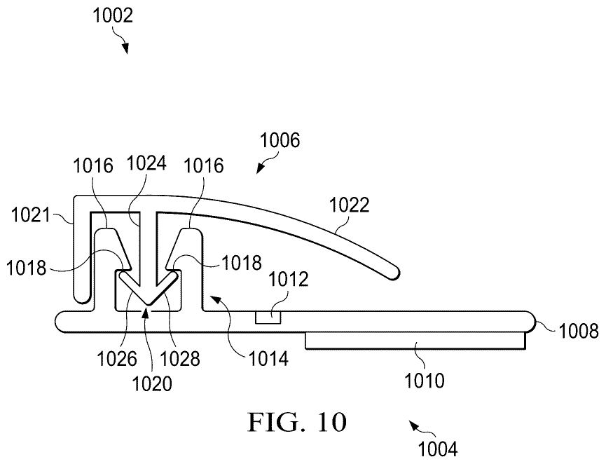

FIG. 10 illustrates an endcap trim accessory 1002 for speeding the installation process of a self-bonding FRPs 402. The endcap trim accessory 1002 enables the securing of an edge of self-bonding FRPs 402 when not adjacent to an additional self-bonding FRP and providing an endcap for protecting the edge. The endcap trim accessory 1002 includes a first portion 1004 that connects to a substrate and a second portion 1006 that connects with 1004 to cover the edge of a self-bonding FRP 402. The first portion 1004 includes a backplate 1008 that connects to a substrate. A first portion of a back side of the backplate 1008 includes an adhesive 1010 that is used for securing the backplate 1008 of the first portion 1004 to the substrate. In one embodiment, the adhesive 1010 only covers a portion of the back side of the backplate 1008 (other areas may be covered). While covering a portion of the back side of the backplate 1008 with adhesive 1010 has been described, it will be understood that lesser and greater areas on the back side of the backplate 1008 may be covered with the adhesive 1010.

The front side of the backplate 1008 includes an edge marker 1012 marking the edge placement of a self-bonding FRP 402. The front side of the backplate 1008 of the first portion 1004 has a female connector 1014 extending perpendicularly therefrom on one end of the backplate 1008. The female connector 1014 includes a pair of latching members 1016 extending perpendicular from the backplate 1008. Each of the pair of latching members 1016 define a ledge 1018 for securing a male connector 1020. The latching members 1016 may flexibly move laterally to allow disengagement of the male connector 1020.

The second portion 1006 of the trim accessory 1002 comprises a flexible plate 1022 and the male connector 1020 extending therefrom. A lateral plate 1021 extends from the flexible plate 1022 in the same direction as the male connector 1020. The flexible plate 1022 has a slightly curved shape extending downward toward the backplate 1008 for holding an edge a self-bonding FRP 402 against the front surface of the backplate 1008. The flexible nature of the flexible plate 1022 enables the corner trim accessory 1002 to accommodate multiple self-bonding FRP 402 thicknesses. The flexible nature further enables the flexible plate 1022 to provide a holding forces against the edge of the self-bonding FRPs 402. The lateral plate 1021 extends from the flexible plate 1022 to provide an endcap for the edge of the self-bonding FRP 402.

The male connector 1020 includes a horizontal member 1024 extending perpendicularly from the surface of the flexible plate 1022. At the end of the horizontal member 1024, opposite from the connection point with the flexible plate 1022, an arrow shaped connector includes a first wing 1026 and a second wing 1028 enabling the male connector 1020 to latch into the female connector 1014. When snapped into place, the first and second wings 1026, 1028 click into place on the ledges 1018 of the female connector 1014 to secure the flexible plate 1022 to the backplate 1008. This enables the endcap trim accessory 1002 to secure an edge of a self-bonding FRP 402 and provide an endcap protection for the edge. The endcap trim accessory 1002 speeds up install times and enhances ease of use of the self-bonding FRPs 402.

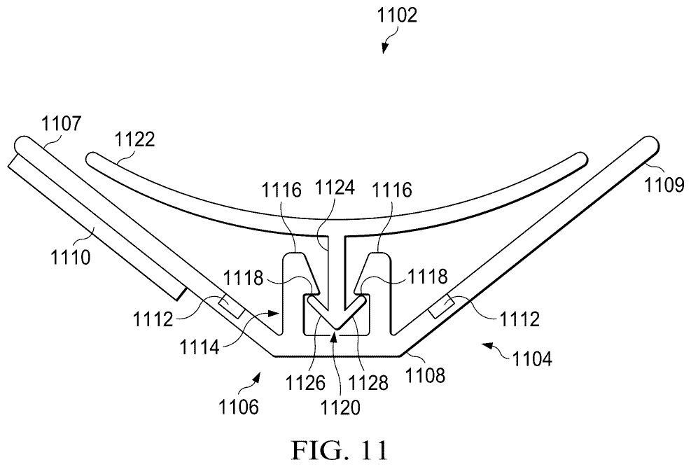

FIG. 11 illustrates a corner trim accessory 1102 for speeding the installation process of self-bonding FRPs 402. The corner trim accessory 1102 enables the interconnection of two adjacent self-bonding FRPs on an inside corner of a substrate. The corner trim accessory 1102 includes a first portion 1104 that connects to adjacent substrates forming an inside corner and a second portion 1106 that connects with and secures a pair of adjacent self-bonding FRPs that interconnect at the inside corner. The first portion 1104 includes a first backplate portion 1107 that connects to a first substrate forming an inside corner, a second backplate portion 1108 that is located along the inside corner and a third backplate portion 1109 that connects to a second substrate forming the inside corner. A first back side of the first backplate portion 1107 includes an adhesive 1110 that is used for securing the first backplate portion 1107 of the first portion 1104 to the first substrate. In one embodiment, the adhesive 1110 only covers a portion of the back side of the first backplate portion 1107 (other areas may be covered). The back side of the third backplate portion 1109 does not include any adhesive so the third backplate portion 1109 can be inserted under the self-bonding FRP 402 installed on the second substrate forming the inside corner. While covering a portion of the backside of the first backplate portion 1108 with adhesive 1110 has been described, it will be understood that lesser and greater areas on the back side of the first backplate portion 1107 and the third backplate portion 1109 and even the second backplate portion 1108 may be covered with the adhesive 1110.

The front side of the first backplate portion 1107 and the third backplate portion 1109 includes an edge marker 1112 marking the edge placement of the first and second self-bonding FRPs 402 forming the inside corner. The front side of the second backplate portion 1108 of the first portion 1104 has a female connector 1114 extending perpendicularly therefrom. The female connector 1114 includes a pair of latching members 1116 extending perpendicular from the second backplate portion 1108. Each of the pair of latching members 1116 define a ledge 1118 for securing a male connector 1120. The latching members 1116 may flexibly move laterally to allow disengagement of the male connector 1120.

The second portion 1106 of the corner trim accessory 1102 comprises a flexible plate 1122 and the male connector 1120 extending therefrom. The flexible plate 1122 has a slightly curved shape with the edges curving away from the direction that the male connector extends for holding self-bonding FRPs 402 against the front surface of the first backplate portion 1107 and the second backplate portion 1109. The flexible nature of the flexible plate 1122 enables the corner trim accessory 1102 to accommodate multiple self-bonding FRP 402 thicknesses. The flexible nature further enables the flexible plate 1122 to provide a holding forces against the edges of the self-bonding FRPs 402 intersecting at the inside corner.

The male connector 1120 includes a horizontal member 1124 extending perpendicularly from the outer curving surface of the flexible plate 1122. At the end of the horizontal member 1124, opposite from the connection point with the flexible plate 1122, an arrow shaped connector includes a first wing 1126 and a second wing 1128 enabling the male connector 1120 to latch into the female connector 1114. When snapped into place, the first and second wings 1126, 1128 click into place on the ledges 1118 of the female connector 1114 to secure the flexible plate 1122 to the backplate. This enables the corner trim accessory 1102 to secure edges of self-bonding FRPs 402 forming the inside corner to their respective substrates. The corner trim accessory 1102 speeds up install times and enhances ease of use of the self-bonding FRPs 402 that are installed on inside corners.

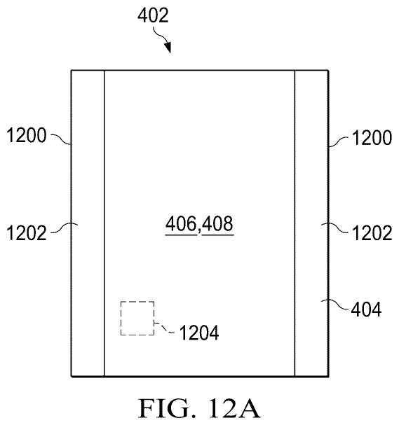

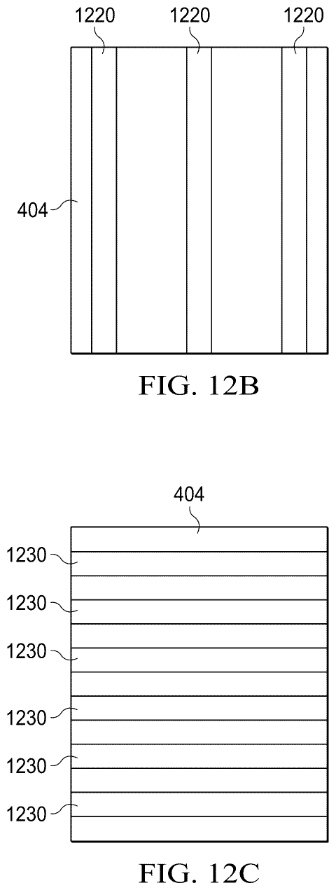

Referring now to FIG. 12A, there is illustrated a top view of a self-bonding FRP 402. This view illustrates the manner in which the adhesive layer 406 and release liner layer 418 are laminated to the backside of the FRP 404. Lamination of the adhesive layers 406 and release liner layers 408 to the backside of the FRP 404 can provide difficulties in aligning the edges of the FRP 404 with the edges of the adhesive layers 406 and tape layers 418. In order to overcome this problem, the lamination process would have the dimensions of the adhesive layers 406 and 408 be slightly smaller than the dimensions of the FRP 404 along the edges 1200. Thus, a boundary strip 1202 having no adhesive layer 406 or release liner layer 418 would be defined along the edges 1200 of the FRP 404. The particular size of the boundary area with 1202 may be determined based upon design implementations. In further embodiments, the adhesive layers 406 and release liner layer 408 may cover the entire backside of the FRP 404 with no boundary strips. In a further embodiment, an RFID tag 1204 can be applied to a FRP 404 to detect temperature, humidity, moisture, strain, structural issues. The ultra-high frequency passive RFID tag 1204 would be applied to the FRP 404 before the application of the adhesive layer 406 and release liner layer 418.

FIGS. 12B and 12C illustrate alternative embodiments wherein the adhesive layer 406 and the release liner layer 418 rather than covering substantially all of the backside of the FRP 404 may cover only portions of the backside of the FRP 404 in rectangular strips 1220 running in either the vertical direction (FIG. 12B) or rectangular strips 1230 in the horizontal direction (FIG. 12C). It will also be appreciated that adhesive layer 406 and release liner layer 418 portions may comprise any shape or be placed in any position on the backside of the FRP 404. It will further be appreciated that the general shape of the self-adhesive FRP 402 need not be in a substantially rectangular or square configuration but may be in any shape according to the present invention.

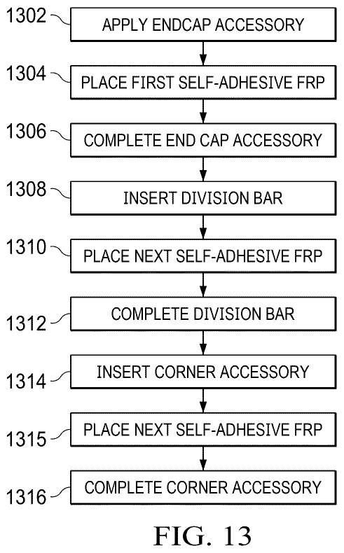

FIG. 13 illustrates a flow diagram of the installation of the self-bonding FRP 402 to a substrate. Initially, at step 1302, the endcap trim accessory 1002 is applied to an edge by placing the first portion 1004 on a substrate. Next, the self-bonding FRP 402 is placed at step 1304 upon the top surface of the first portion 1004 such that its edge of the FRP aligns with the edge marker 1012. The self-bonding FRP 402 is then secured to the substrate by applying pressure or other adhesive activation means. The second portion 1006 of the endcap trim accessory 1002 is connected to the first portion 1004 in order to secure the edge of the self-bonding FRP 402 to complete the endcap accessory installation at step 1306.

Next, the division bar trim accessory 902 has one side of the first portion 904 inserted under the edge of the self-bonding FRP 402 at step 1308 that is currently mounted on the substrate such that the edge aligns with the edge marker 912. The second self-bonding FRP 402 is then placed on the substrate with its edge placed at step 1310 on the top surface of the first portion 904 of the division bar trim accessory 902 such that the edge aligns with the edge marker 912. The second self-bonding FRP 402 may then be secured to the substrate and the division bar trim accessory 902 by applying pressure or some other adhesive activation means. The second portion 906 of the division bar trim accessory 902 is then connected to the first portion 904 to secure each edge of the two adjacent self-bonding FRPs 402 to complete the installation of the trim assembly at step 1312.

The further installation of self-bonding FRPs 402 may include placing additional adjacent self-bonding FRPs 402 that are interconnected via additional trim accessories 902 or protecting a stopping edge of the self-bonding FRP 402 using an additional endcap trim accessory 1002. While any of these additional trim accessories 902 or endcap trim accessories 1002 may be utilized for purposes of the flow diagram of FIG. 13, when an inside corner is reached this necessitates the use of a corner trim accessory 1102. A portion of the first portion 1104 of the corner trim accessory 1102 is slid under an edge of the self-bonding FRP 402 currently mounted on a first substrate of the inside corner at step 1314 such that an edge of the self-bonding FRP 402 aligns with edge marker 1112. The self-bonding FRP 402 forming the other substrate of the inside corner is then placed on the other top surface of the first portion 1104 of the corner trim accessory 1102 at step 1315. The self-bonding FRP 402 is secured to the substrate and corner trim accessory 1102 by applying pressure or using some other type of adhesive activation means. The edge of the self-bonding FRP 402 is also aligned with the edge marker 1112. The assembly of the corner trim accessory is completed at step 1316 by connecting the second portion 1106 with the first portion 1104 such that the flexible plate 1122 secures each edge of the self-bonding FRPs 402 forming the inside corner.

The described panels provide a number of advantages. They provide a moisture resistant panel that can be applied to walls or other structures. They provide repositioning ability until pressure is applied to the panel. This is because less surface area is connected to the substrate a panel is positioned on until the pressure is applied to the outer surface of the panel.

Although the preferred embodiment has been described in detail, it should be understood that various changes, substitutions and alterations can be made therein without departing from the spirit and scope of the invention as defined by the appended claims.

What is claimed is:

1. A self-bonding panel, comprising:
a fiberglass reinforced panel having a front side and a backside;
at least one adhesive layer applied to the backside of the fiberglass reinforced panel; and
at least one release liner layer applied to a surface of the at least one adhesive layer opposite the fiberglass reinforced panel.

2. The self-bonding panel of claim 1, wherein the at least one adhesive layer further comprises:
a first adhesive layer applied to the backside of the fiberglass reinforced panel;
a carrier layer applied to the first adhesive layer opposite the fiberglass reinforced panel; and
a second adhesive layer applied to the carrier layer opposite the first adhesive layer.

3. The self-bonding panel of claim 2, wherein the at least one adhesive layer further comprises:
a performance layer on the second adhesive layer opposite the carrier layer; and
a third adhesive layer located on the performance layer opposite the second adhesive layer.

4. The self-bonding panel of claim 2, wherein the carrier layer comprises a closed cell foam material.

5. The self-bonding panel of claim 1, wherein the at least one release liner layer comprises:
a first release coating layer located on the at least one adhesive layer opposite the fiberglass reinforced panel;
a release liner located on the first release coating layer opposite the adhesive layer; and
a second release coating layer located on the release liner opposite the first release coating layer.

6. The self-bonding panel of claim 1, wherein the at least one release liner layer comprises:
a first release coating layer located on the at least one adhesive layer opposite the fiberglass reinforced panel; and
a release liner located on the first release coating layer opposite the adhesive layer.

7. The self-bonding panel of claim 1, wherein the at least one release liner layer further comprises a texture layer, the texture layer configured to impart peaks and valleys into the at least one adhesive layer to mechanically enhance repositionability of the at least one adhesive layer.

8. The self-bonding panel of claim 1, wherein the at least one release liner layer is configured to be removed from the at least one adhesive layer to expose the at least one adhesive layer for connecting the self-bonding panel to a substrate.

9. The self-bonding panel of claim 1, wherein the at least one adhesive layer does not extend completely across a predetermined direction of the backside of the fiber reinforced panel such that a boundary strip is defined on opposing edges of the backside of the fiber reinforced panel that does not contain the adhesive layer.

10. The self-bonding panel of claim 1, wherein the at least one adhesive layer comprises a plurality of horizontal bands of adhesive layers extending across the backside of the fiber reinforced panel.

11. The self-bonding panel of claim 1, wherein the at least one adhesive layer comprises a plurality of vertical bands of adhesive layers extending across the backside of the fiber reinforced panel.

12. A system comprising:
a plurality of self-bonding panels configured to connect to a substrate, each of the plurality of self-bonding panels further comprising:
a fiberglass reinforced panel having a frontside and a backside;
at least one adhesive layer applied to the backside of the fiberglass reinforced panel;
at least one release liner layer applied to a surface of the at least one adhesive layer opposite the fiberglass reinforced panel; and
at least one connection accessory for securing edges of the plurality of self-bonding panels to the surface.

13. The system of claim 12, wherein the at least one connection accessory comprises an endcap trim accessory, the endcap trim accessory comprising:
a first member having a first side for connecting the endcap trim accessory to the substrate and a second side;
a second flexible member configured to secure an edge of an associated self-bonding panel to the second side of the first member and to protect the edge of the associated self-bonding panel when connected to the first member; and
a connector configured to securely connect the second flexible member to the first member.

14. The system of claim 12, wherein the at least one connection accessory comprises a division bar trim accessory, the division bar trim accessory comprising:
a first member having a first side for connecting the division bar trim accessory to the substrate and a second side;
a second flexible member configured to secure adjacent edges of two adjacent self-bonding panels to the second side of the first member when connected to the first member; and
a connector configured to securely connect the second flexible member to the first member.

15. The system of claim 14, wherein the division bar trim accessory further includes an adhesive layer on at least a portion of the first side to connect division bar trim accessory to the substrate.

16. The system of claim 12, wherein the at least one connection accessory comprises an inside corner trim accessory, the inside corner trim accessory comprising:
a first member having a first side for connecting the inside corner trim accessory to the substrate forming an inside corner and a second side;
a second flexible member configured to secure adjacent edges of two adjacent self-bonding panels forming the inside corner when connected to the first member; and
a connector configured to securely connect the second flexible member to the first member.

17. The system of claim 12, wherein the at least one adhesive layer each further comprise:
a first adhesive layer applied to the backside of the fiberglass reinforced panel;
a carrier layer applied to the first adhesive layer opposite the fiberglass reinforced panel; and
a second adhesive layer applied to the carrier layer opposite the first adhesive layer.

18. The system of claim 17, wherein the at least adhesive one layer further comprises:
a performance layer on the second adhesive layer opposite the carrier layer; and
a third adhesive layer located on the performance layer opposite the second adhesive layer.

19. The system of claim 12, wherein the at least one adhesive layer does not extend completely across a predetermined direction of the backside of the fiber reinforced panel such that a boundary strip is defined on opposing edges of the backside of the fiber reinforced panel that does not contain the adhesive layer.

20. The system of claim 12, wherein the at least one release liner layer comprises:
a first release coating layer located on the at least one adhesive layer opposite the fiberglass reinforced panel; and
a release liner located on the first release coating layer opposite the adhesive layer.

21. The system of claim 12, wherein the at least one release liner layer further comprises a texture layer, the texture layer configured to impart peaks and valleys into the at least one adhesive layer to mechanically enhance repositionability of the at least one adhesive layer.

22. The system of claim 12, wherein the at least one release liner layer is configured to be removed from the at least one adhesive layer to expose the at least one adhesive layer for connecting a self-bonding panel to the substrate.

23. A self-bonding panel, comprising:
a fiberglass reinforced panel having a front side and a backside;
at least one adhesive layer applied to the backside of the fiberglass reinforced panel, wherein the at least one adhesive layer further comprises:
a first adhesive layer applied to the backside of the fiberglass reinforced panel;
a carrier layer applied to the first adhesive layer opposite the fiberglass reinforced panel;
a second adhesive layer applied to the carrier layer opposite the first adhesive layer;
at least one release liner layer applied to a surface of the at least one adhesive layer opposite the fiberglass reinforced panel, wherein the at least one release liner layer comprises:
a first release coating layer located on the at least one adhesive layer opposite the fiberglass reinforced panel;
a release liner located on the first release coating layer opposite the adhesive layer; and
a second release coating layer located on the release liner opposite the first release coating layer; and
a texture layer located within the at least one release liner layer configured to impart peaks and valleys into the at least one adhesive layer to mechanically enhance repositionability of the at least one adhesive layer.
